(19) United States
(12) Patent Application Publication
(10) Pub. No.: US 2011/0183146 A1
(43) Pub. Date: Jul. 28, 2011

(54) GLASS HARDENING METHODS AND COMPOSITIONS

(76) Inventors: Jay Morell Wendell, JR., The Woodlands, TX (US); David Howe, The Woodlands, TX (US); C. Wayne Smith, Bryan, TX (US); Catherine Marie Sincich, College Station, TX (US)

(21) Appl. No.: 12/999,574

(22) PCT Filed: Jun. 16, 2009
(86) PCT No.: PCT/US2009/047500

§ 371 Date: Apr. 6, 2011

Related U.S. Application Data
(60) Provisional application No. 61/061,944, filed on Jun. 16, 2008.
(60) Provisional application No. 61/061,935, filed on Jun. 16, 2008.

(51) Int. Cl. B32B 17/06; C09D 7/12; C03C 17/30

(52) U.S. Cl. 428/429; 106/287.1; 65/30.1

(57) ABSTRACT

The present invention provides a composition for hardening glass, wherein said composition comprises one or more silane-based compounds. The present invention also provides a method for hardening glass by applying said composition to a glass and incubating said glass with said composition. The present invention also provides a hardened glass prepared in accordance with the methods and compositions of the present invention.

### RELATED APPLICATIONS

This Application is related to Provisional Patent Application No. 61/061,944, filed on Jun. 16, 2008, and Provisional Patent Application No. 61/061,935, filed on Jun. 16, 2008, the entirety of both of which are hereby incorporated into this application by reference.

### BACKGROUND

Hardened or tempered glass generally refers to glass that has been processed by thermal and/or chemical treatments for enhanced strength. Such glasses are more resistant to shattering into small fragments if broken. Hardened glasses are also more resistant to penetration by objects such as bullets, rocks, and the like. Accordingly, such glasses have found many applications for both safety and security purposes. However, current methods to harden glass (e.g., acrylic-based reagents and methods) require many different reagents and long incubation periods. Furthermore, such methods usually produce hardened glasses that may be bulky and thick. Such hardened glasses may also have limited transparency. Therefore, there is currently an unmet need for glass hardening methods and compositions that require a minimal amount of reagents and a short incubation period to produce transparent and lightweight glasses with higher impact resistance per cross-sectional area than conventionally-prepared hardened glasses.

### SUMMARY OF THE INVENTION

In one aspect, the present invention pertains to compositions for hardening glass, where the compositions generally comprise one or more silane-based compounds, such as amino-silanes, alkoxy-silanes, di-silanes, alkyl silanes, and the like. The compositions of the present invention may further comprise one or more glycols, such as propylene glycol, ethylene glycol, polyethethylene glycol, silicon glycol, and the like. In other examples, the compositions of the present invention may further include one or more alcohols, such as methanol, octanol, and the like. In further examples, the compositions of the present invention may include water, such as de-ionized water.

In another aspect, the present invention provides methods for hardening glass. Such methods generally include the application of a composition of the present invention to a glass followed by an incubation period to allow the composition to set with the glass. In various embodiments, the application and incubation steps may take place in a container. In other embodiments, the incubation may take place in the presence of a vacuum force, desirably, in an embodiment, for about 4 hours. In further embodiments, the application and incubation steps may both take place in the presence of a vacuum force, desirably in a container.

In additional embodiments, the glass hardening methods of the present invention may further comprise the use of a curing agent. Furthermore, the glass hardening methods of the present invention can be repeated several times to optionally form multiple layers with a glass.

In another aspect, the present invention provides hardened glasses that comprise a layer. Desirably, the layer can be formed by applying a composition of the present invention to the glass and incubating the glass in accordance with one or more of the glass hardening methods of the present invention.

### BRIEF DESCRIPTION OF THE DRAWINGS

The foregoing and other features and aspects of the present invention will be best understood with reference to the following detailed descriptions of specific embodiments of the invention, when read in conjunction with the accompanying drawings, wherein:

FIG. 1 is a depiction of a hardened glass that has been treated with a composition of the present invention.

FIG. 2A shows a perspective view of a covered container that may be suitable for hardening glass in accordance with various embodiments of the present invention.

FIG. 2B shows an un-covered and top view of the container in FIG. 2A, where two glasses are positioned horizontally on the top portion of the container.

FIG. 3 shows a cross-section scanning electron micrograph (SEM) image of a hardened glass treated with a glass hardening method of the present invention at atmospheric pressure. The method was repeated two times to form two layers.

FIG. 4 shows a cross-sectional SEM image of a hardened glass treated with a glass hardening method of the present invention under vacuum pressure. The method was repeated two times to form two layers.

FIG. 5 shows a photograph that compares glass fragments from un-treated glass and treated glass (from FIG. 4). The fragments from the untreated glass appear to have sharper edges.

FIG. 6 shows more focused photographs of glass fragments from the experiment in FIG. 5. FIG. 6A shows focused views of glass fragments from the un-treated glass, whereas FIG. 6B shows focused views of glass fragments from the treated glass. The fragments from the treated glass appear to be smoother and more rounded.

FIG. 7 shows photographs that compare bullet penetration through 1-inch thick untreated glass (FIG. 7A) and ½ inch thick treated glass (FIG. 7B), where the glass was treated with a glass hardening method of the present invention under vacuum pressure. As shown in the images, the bullet penetrated the un-treated glass but not the treated glass.

### DETAILED DESCRIPTION OF THE INVENTION

The definitions and explanations that follow are meant and intended to be controlling in any future construction unless clearly and unambiguously modified in the following Detailed Description or when application of the meaning renders any construction meaningless or essentially meaningless. In cases where the construction of the term would render it meaningless or essentially meaningless, the definition should be taken from Webster's Dictionary, 3^{rd} Edition. Definitions and/or interpretations should not be incorporated from other patent applications, patents, or publications, related or not, unless specifically stated in this specification or if the incorporation is necessary for maintaining validity.

Other than in the operating examples, or where otherwise indicated, all numbers expressing quantities of components used herein are to be understood as modified in all instances by the term “about.”

The present invention pertains to compositions and methods for hardening glass as well as hardened glasses. As used herein, a glass or a glass substrate (as used interchangeably) generally refers to a solid and substantially transparent object that may comprise silica as its main component. Many glasses and glass substrates may also be substantially porous.

As used herein, hardened, treated or tempered glass (as used interchangeably) generally refers to glass that has been processed by thermal and/or chemical treatments for enhanced strength. Likewise, glass hardening generally refers to the thermal and/or chemical treatment of glass for enhanced strength.

As used herein, the ability of a composition to set with a glass generally refers to the ability of the composition to bond with one or more functional groups of a glass substrate (e.g., silicon). Such bonding may occur via covalent bonding, ionic bonding, and the like. Such bonding may also occur on and/or below the surface of the glass. Furthermore, such bonding may occur after a composition penetrates the glass through various pores that may be present on a glass substrate.

As used herein, a layer generally refers to a composition of the present invention that has set with the glass. Such setting may occur on and/or below the surface of the glass. Furthermore, layers in the present invention may or may not be uniform. For instance, layers may be embedded with a glass substrate and/or other layers. Such embedding may occur through various pores on a glass substrate or other layers.

The compositions of the present invention can generally comprise one or more silane-based compounds. The compositions of the present invention can also comprise, in various combinations, one or more glycols, one or more alcohols, and water. In various embodiments, the compositions of the present invention can also contain additional compounds.

### Silane-Based Compounds

Silane-based compounds of the present invention generally refer to molecules with at least one silicon group. Many of the silane-based compounds of the present invention can generally be characterized by the structural formula below:

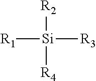

where any one of the R groups can be, without limitation, and in various combinations, a hydrogen group, an alkyl group, an alkoxy group, an amino group, an amino-alkyl group, a monovalent substituent group, another silane-based compound, and/or an isocyanate group. One or more of the R groups may also constitute various combinations of the aforementioned groups. However, the scope of the silane-based compounds of the present invention is not limited to the aforementioned structural formula and description. Rather, the above formula and description are only exemplary.

More specific non-limiting examples of silane-based compounds of the present invention can include amino-silane, alkoxy-silane, di-silane, alkyl-silane, methoxy-silane, methyltrimethoxysilane (MTMS), aminoethylaminopropylsilane, methoxy-terminated aminosilsesquioxanes, benzylaminoethylaminopropyltrimethoxysilane, aminoethylaminopropyltrimethoxysilane, dimethyldimethoxysilane, aminopropyl-triethoxysilane, vinyltrimethoxysilane, vinylbenzylaminoethylaminopropyltrimethoxy silane, methacryloxy propyltriethoxysilane, gylcidoxypropyltrimethoxysilane, polydimethyl siloxane, octyltriethoxysilane, chloropropyltrimethoxysilane, glycidoxypropylmethyldiethoxysilane, phenyltrimethoxysilane, phenyltriethoxysilane, mercaptopropyltrimethoxysilane, bis-triethoxysilylpropyldisulfidosilane, vinyl tris(methoxyethoxy)silane, n-hexyltrimethoxysilane, n-octyltriethoxysilane, n-octyltrimethoxysilane, t-butyltrimethoxysilane, isobutyltriethoxysilane, and the like.

The compositions of the present invention may constitute one or more silane-based compounds in various concentrations. For instance, in one example, the silane-based compounds of the present invention may constitute from about 60% by weight to about 100% by weight of the composition. In another example, the silane-based compounds of the present invention may constitute from about 99% by weight to about 100% by weight of the composition. In a more specific example, a composition of the present invention may constitute from about 99.9% by weight to about 100% by weight of MTMS.

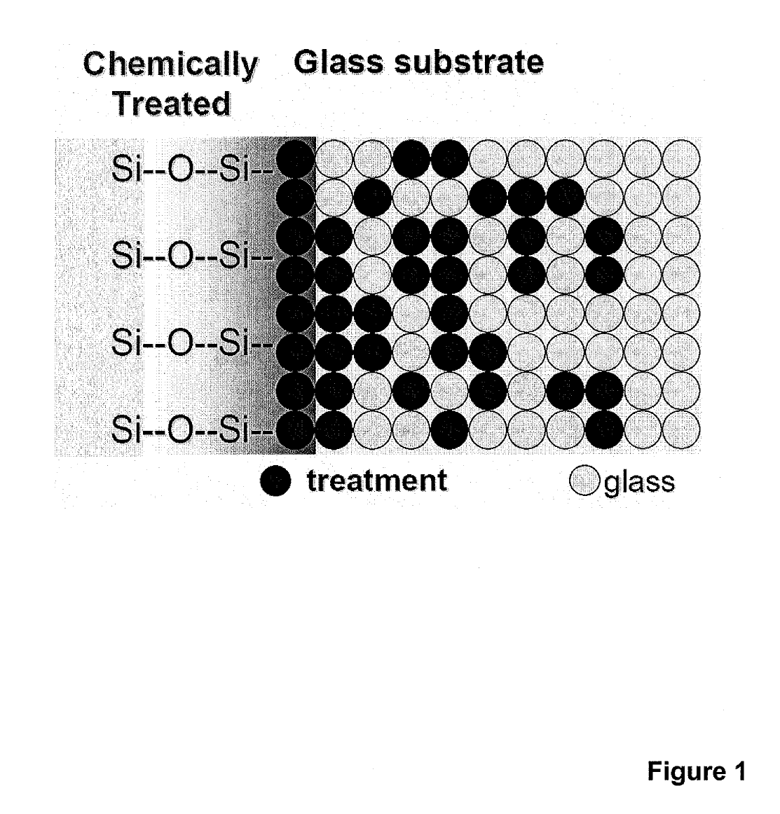

Without being bound by theory, it is envisioned that silane-based compounds of the present invention can serve as adhesion promoters. For instance, as illustrated in FIG. 1, the silicon groups of the silane-based compounds may bond with the silicon groups of a glass substrate. The mechanism by which such bonding can occur is well known in the art. Furthermore, one can envision that such bonding may occur on the surface and/or below the surface of the glass. For instance, in one example, the silane-based compounds of the present invention may penetrate through pores that may be present on a glass surface. Thereafter, the silane-based compounds may form bonds with the silicon groups of the glass substrate below the surface of the glass. In another example, the silane-based compounds of the present invention may remain on the surface of the glass and bond with the surface silicon groups of the glass substrate. In further embodiments, the silane-based compounds of the present invention may bond with silicon groups that are on and below the surface of a glass substrate.

The silane-based compounds of the present invention can provide various advantages. For instance, unlike conventional acrylics, silane-based compounds of the present invention can be resistant to yellowing if repeatedly and extensively exposed to ultraviolet light. It is also envisioned that the silane-based compounds of the present invention may imbue UV protection to glass substrates. In addition, since the silane-based compounds of the present invention are generally smaller molecules than their acrylic-based counterparts, they may be able to penetrate deeper into the natural pores of glass, thereby producing greater glass laminate adhesion.

### Glycols

In the present invention, glycols generally refer to chemical compounds with at least two hydroxyl groups. Exemplary but non-limiting examples of glycols in the present invention can include without limitation propylene glycol, ethylene glycol, polyethethylene glycol, silicon glycol, and the like.

The compositions of the present invention may constitute one or more glycols in various concentrations. For instance, in one example, the glycols of the present invention may constitute from about 0.001% by weight to about 40% by weight of the composition. In another example, the glycols of the present invention may constitute from about 0.01% by weight to about 1% by weight of the composition. In a more specific example, a composition of the present invention may constitute from about 0.001% by weight to about 0.1% by weight of propylene glycol. In other examples, however, glycols may be entirely absent from a composition of the present invention.

Without being bound by theory, it is envisioned that glycols of the present invention can serve as surface tension breakers that can enhance the strength properties of the treated glasses. This can occur because glycols may react with the silane-based compounds of the present invention to form silicon glycol copolymers that have enhanced penetration properties into the glass pores. Such copolymers can also enhance the strength of any formed layers with the glass.

### Alcohols

In the present invention, alcohols generally refer to chemical compounds with at least one hydroxyl group bound to a carbon atom. Exemplary but non-limiting examples of alcohols in the present invention can include methanol, octanol, ethanol, propanol, iso-propanol, butanol, cyclohexanol, phenol, and the like. Without being bound by theory, it is envisioned that alcohols of the present invention can serve as carrier agents or solvents.

The compositions of the present invention may constitute one or more alcohols in various concentrations. For instance, in one example, the alcohols of the present invention may constitute from about 0.01% by weight to about 25% by weight of the composition. In another example, the alcohols of the present invention may constitute from about 0.01% by weight to about 1% by weight of the composition. In a more specific example, a composition of the present invention may constitute from about 0.001% by weight to about 0.1% by weight octyl alcohol. In further embodiments, the compositions of the present invention may not contain any alcohols.

### Water

In the present invention, water generally refers to a molecule with a molecular formula of H₂O. As used in the present invention, water may be in pure form in some embodiments, such as in de-ionized form.

The compositions of the present invention may constitute various concentrations of water. For instance, in one example, water may constitute from about 0.01% by weight to about 50% by weight of the composition. In another example, water may constitute from about 0.01% by weight to about 25% by weight of the composition. In another example, water may constitute from about 0.001% by weight to about 0.1% by weight of the composition. In further embodiments, the compositions of the present invention may not contain any water.

The aforementioned components can form a broad array of compositions that fall within the scope of the present invention. In one example, a composition of the present invention may comprise about 100% by weight methyltrimethoxysilane (MTMS). In another example, a composition of the present invention may comprise about 99.9% by weight MTMS and about 0.01% by weight the combination of propylene glycol, water and octyl alcohol. In another example, a composition of the present invention may contain about 10% by weight methanol and about 90% by weight Z-6020 (Dow Corning chemical compound comprising ˜60% Aminoethylaminopropyltrimethoxysilane, ˜15-40% Methoxysilane, ˜1% methanol, and ˜1% ethylenediamine). In further embodiments, a composition of the present invention may contain about 50% by weight MTMS and about 50% by weight Z-6341 (Dow Corning chemical compound comprising ˜60% N-Octyltriethoxysilane, ˜2% branched octyltriethoxysilanes, and ˜1% ethanol)

The compositions of the present invention can be used by various methods to harden glass. Such methods generally comprise the application of a composition to a glass followed by its incubation for a period of time that would be sufficient for setting to occur. In some embodiments of the present invention, the glass may optionally be rinsed and/or washed before such treatment. For instance, in one embodiment, the glass to be treated may be rinsed with acetone. In another embodiment, the glass may be washed with soap and/or water. Thereafter, the glass may be dried by various methods (e.g., heating in a heat enclave, such as a whirlpool oven).

A glass to be treated may also be placed in various positions. For instance, a glass may be positioned horizontally or vertically. The glass in other embodiments may also be positioned at a certain angle.

Once the glass is placed in a desired position, a composition of the present invention may be applied to the glass by various mechanisms. For instance, a composition may be sprayed onto a surface of a glass in one embodiment. In another embodiment, a composition may be poured onto the glass such that the glass becomes immersed and/or submerged in the composition.

In other embodiments of the present invention, one or more curing agents may also be used to facilitate the hardening of the glass. Such curing agents include without limitation ultraviolet light, radiation (e.g., y radiation), heat, and catalysts (e.g., titanate). The curing agents may be applied to the compositions of the present invention before, during, or after treatment.

The glass to be treated may also be incubated under various conditions. For instance, in one embodiment, the incubation may occur at atmospheric pressure. In another embodiment, incubation may take place in the presence of a vacuum force. In a more specific embodiment, the incubation may take place in the presence of a vacuum force of about 27 torr to about 28 torr. However, other vacuum forces may also be suitable. Non-limiting examples of such suitable ranges include from about 20 torr to about 29 torr, or from about 23 torr to about 24 torr. However, various embodiments will function in any vacuum conditions.

In another embodiment, a glass to be treated may first be subject to a vacuum force. A composition of the present invention may then be applied to the glass that is under vacuum pressure, followed by an incubation period. In another embodiment, a composition of the present invention may first be applied to the glass. Thereafter, a vacuum force may be actuated followed by an incubation period.

In embodiments utilizing a vacuum, the vacuum may be applied by any mechanism common in the art. Various non-limiting examples include but are not limited to hypobaric chamber, suction hose, vacuum chamber, hand held vacuum system, vacuum hose, and/or the like. In general, any vacuum can be used.

Applicants have observed that the use of vacuum force during treatment is capable of enhancing the strength of the hardened glasses. Without being bound by theory, it is envisioned that such effects may be due to the enhanced penetration of the compositions of the present invention through glass pores under vacuum force. As well, a vacuum force is capable of enhancing the bonding of the components.

The incubation period required for hardening glass can also vary depending on the conditions and compositions used, and whether one or more curing agents are employed. For instance, if incubation occurs at atmospheric pressure, then a suitable incubation period may be from about 12 hours to about 72 hours, and possibly for about 12 hours. However, if a vacuum force is used, then a suitable incubation period may be from about 3 hours to about 12 hours, and possibly for about 4 hours. In general, irrespective of the use of a vacuum, any curing time can be used. As such, in various embodiments, curing time is a separate process from a vacuum force process. It is typical that a longer curing time, to a point, results in a harder glass.

In various embodiments utilizing a vacuum, the vacuum time can be optimized. In an embodiment, a vacuum force is applied from between about 10 seconds and about 100 hours. In an alternate embodiment, a vacuum force is applied from between about 10 minutes and about 48 hours. In an alternate embodiment, a vacuum force is applied from between about 60 minutes and about 24 hours. In an alternate embodiment, a vacuum force is applied from between about 12 hours and about 12 hours. In an alternate embodiment, a vacuum force is applied from between about 4 hours and about 6 hours. In general, any vacuum time is acceptable and can be optimized to improve results.

After setting occurs, the methods of the present invention may be repeated several times on a single glass substrate to form multiple layers. Applicants have also observed that the formation of multiple layers can enhance the strength of the treated glasses. Without being bound by theory, it is envisioned that such effects may be due to the enhanced penetration of the compositions of the present invention through glass pores when a glass is treated multiple times. It is further envisioned that the layers of the present invention strengthen one another by inter-layer penetration.

Various equipment may be used to practice the glass hardening methods of the present invention. In some embodiments, such equipment may include a container (either covered or uncovered), a tray, or other similar structures. A non-limiting example of an equipment may include a polyethylene-based open container. In other embodiments, however, treatment may simply occur on a surface without the use of any equipment.

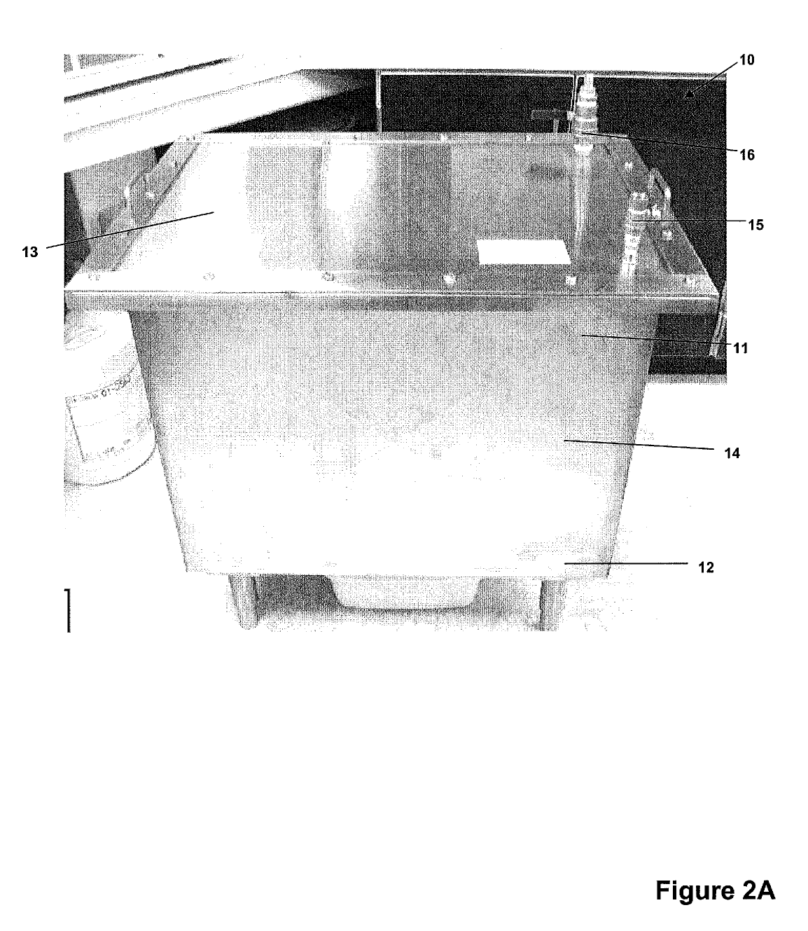

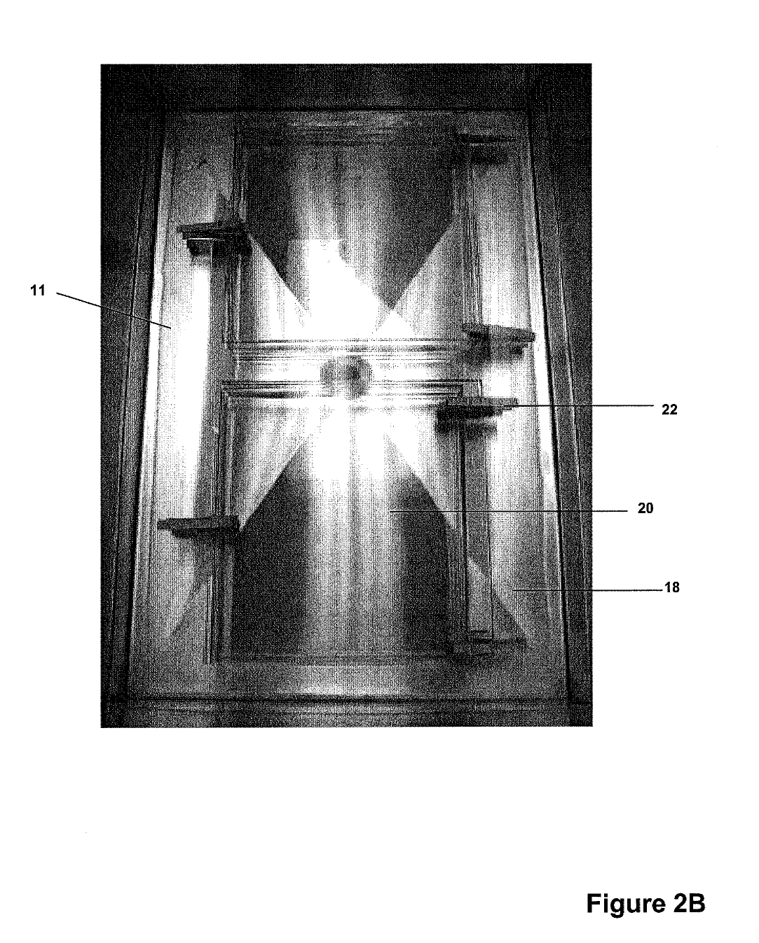

Referring now to FIG. 2A, container 10 is shown as one example of one equipment that can be used to practice various glass hardening methods of the present invention. In this example, container 10 generally comprises top portion 11, bottom portion 12, removable cover 13, housing 14, vacuum outlet port 15, and inlet port 16. FIG. 2B shows a top view of container 10 with cover 13 removed. As shown, top portion 11 comprises edges 18 that can anchor glasses 20 in a horizontal position in the container. Glasses 20 may also be associated with pins 22 for additional support.

Once glasses 20 are positioned on top portion 11 of container 10, a composition of the present invention may be applied to the glass. This can result in the immersion of the glass surface with the composition. The remaining composition may then flow into housing 14 for subsequent dispensing. Thereafter, cover 13 can be placed on top portion 11 if one desires incubation to occur in a closed environment.

In other embodiments, vacuum outlet port 15 may also be connected to a vacuum. The vacuum can then be actuated if one desires for an incubation to take place under a vacuum force. In further embodiments, the vacuum force may be actuated before the application of a composition to the glass. Thereafter, a composition of the present invention may be applied to the glass through inlet port 16.

After the completion of the incubation period, the vacuum force may be disconnected, and cover 13 may be removed. Thereafter, the aforementioned steps may be repeated, especially if one desires additional layers to form with a glass. For instance, a composition comprising one or more silane-based compounds may be applied to the treated glass and then incubated under various conditions (e.g., vacuum force).

From the description above, one can envision that the present invention can comprise various embodiments. For instance, in a specific embodiment, the present invention provides a composition for hardening glass comprising: a) one or more silane-based compounds, wherein said one or more silane-based compounds constitute from about 60% by weight of the composition to about 100% by weight of the composition; b) one or more glycols; and c) one or more alcohols. In another embodiment, the present invention provides a composition for hardening glass comprising: a) one or more silane-based compounds, wherein said one or more silane-based compounds constitute about 99% by weight of the composition; and b) one or more glycols, wherein said one or more glycols constitute about 1% by weight of said composition.

In another specific embodiment, the present invention provides a method of hardening glass, wherein the method comprises: a) applying a composition comprising one or more silane-based compounds to a glass; and b) incubating the glass with the composition under vacuum force. In another specific embodiment, the present invention provides a method of hardening glass, wherein the method comprises: a) applying a composition comprising one or more silane-based compounds to a glass, wherein said one or more silane-based compounds constitute from about 60% by weight of the composition to about 100% by weight of the composition; and b) incubating the glass with the composition.

In another specific embodiment, the present invention provides a hardened glass comprising: a) a glass; and b) a layer, wherein the layer is formed by applying a composition comprising one or more silane-based compounds to the glass, and wherein said one or more silane-based compounds constitute from about 60% by weight of the composition to about 100% by weight of the composition.

Reference will now be made to several examples for practicing the invention. However, Applicants note that these examples are included to demonstrate particular embodiments of the present invention. Therefore, it should be appreciated by those of skill in the art that the methods disclosed in the examples that follow merely represent exemplary embodiments of the present invention. Furthermore, those of skill in the art should, in light of the present disclosure, appreciate that many changes can be made in the specific embodiments described to still obtain a like or similar result without departing from the spirit and scope of the present invention.

### Example 1

### Pre-Treatment of Glass

Several blocks of 12×12 inch glasses with thicknesses from about ¼ inch to about ½ inch were washed with acetone. The glasses were then heat-dried at 200 F in a whirlpool oven for approximately 1 hour.

### Example 2

### Treatment of Glass at Atmospheric Pressure

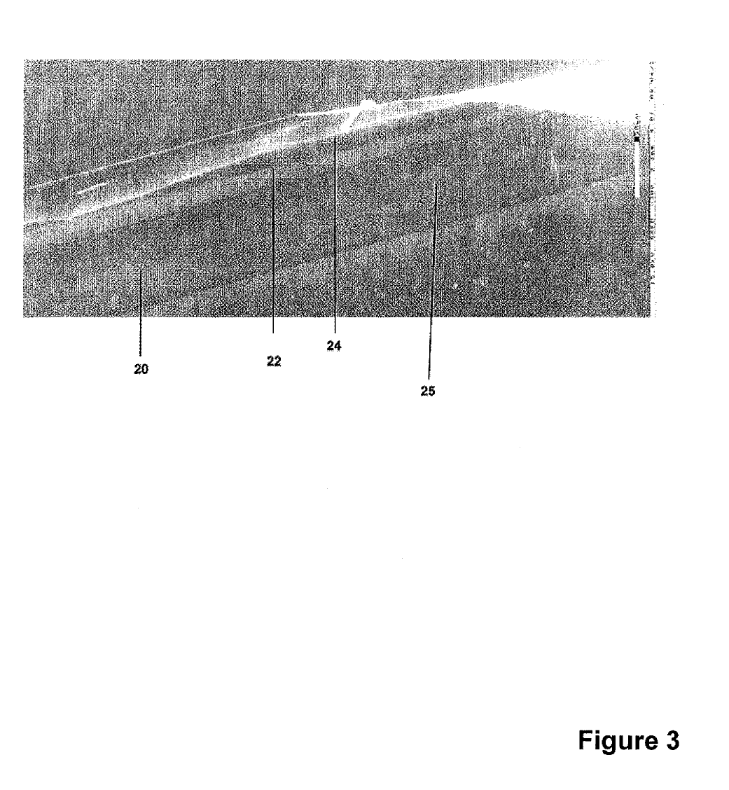

Two pre-treated glasses from Example 1 were placed in a polyethylene-based container. A composition comprising about 99.9% by weight MTMS and about 0.01% by weight the combination of propylene glycol, water and octyl alcohol was then poured onto the surface of the glass. Thereafter, the setting of the composition with the glass was monitored. Optimal setting occurred after 12 hours of incubation at atmospheric pressure. Subsequently, the treated glasses were dried by incubation at ambient temperature for about 12 hours in a vertical and un-stacked position. Next, the glasses were placed back in the container as previously described, and the aforementioned steps were repeated to form an additional layer with the glass. After 12 hours of incubation at atmospheric pressure, the glasses were removed and dried at ambient temperature for about 12 hours as previously described. Next, cross-sectional areas of the glasses were analyzed by an ElectroScan E-3 Environmental Scanning Electron Micrograph (SEM). The SEM image shown in FIG. 3 indicates that the hardened glasses 20 formed first layer 22 and second layer 24. Furthermore, several cracks 25 appeared on the SEM image that spanned glass 20, first layer 22 and second layer 24. Such cracks may indicate that the compositions of the present invention in both the first layer and the second layer penetrated below the surface of glass 20, possibly through various pores.

### Example 3

### Treatment of Glass Under Vacuum Pressure

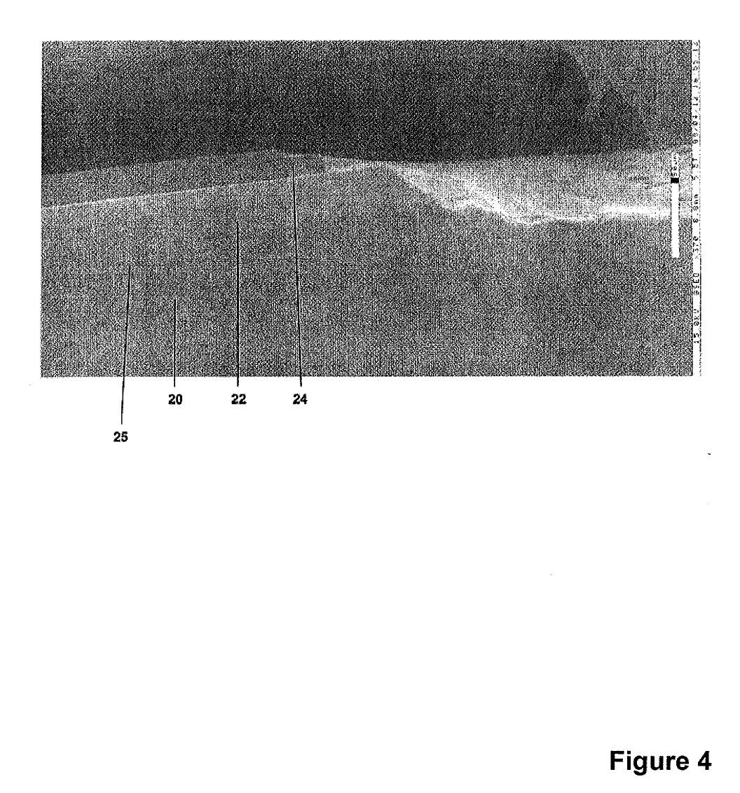

Two pre-treated glasses from Example 1 were placed in container 10 as previously described and shown in FIGS. 2A and 2B. Cover 13 was then placed on the container as shown in FIG. 2B. Thereafter, vacuum outlet port 15 on cover 13 was connected to a vacuum. The vacuum was then actuated to apply a vacuum force of approximately 27-28 torr to the container. Next, a composition comprising about 100% MTMS was applied to the glass through inlet port 16. The setting of the composition with the glass was then monitored. Optimal setting occurred after 4 hours of incubation under vacuum pressure. Subsequently, the glasses were removed from the container and the composition was drawn out of tank 14. The treated glasses were allowed to dry at ambient temperature for about 12 hours in a vertical and un-stacked position. Next, the glasses were placed back in the container as previously described, and the aforementioned steps were repeated to form an additional layer. After 4 hours of incubation, the glass was removed and dried as previously described. Thereafter, cross-sectional areas of the glasses were analyzed by SEM as previously described. The SEM image shown in FIG. 4 indicates that hardened glasses 20 formed first layer 22 and second layer 24 on the surface. Furthermore, the layers appeared to be more uniform than the layers formed at atmospheric pressure, as described in Example 2 and shown in FIG. 3. In addition, several cracks 25 appeared on the SEM image that spanned glass 20, first layer 22 and second layer 24, indicating again that the compositions of the present invention in both layers may have penetrated below the surface of glass 20, possibly through various pores.

### Example 4

### Analysis of Treated Glass

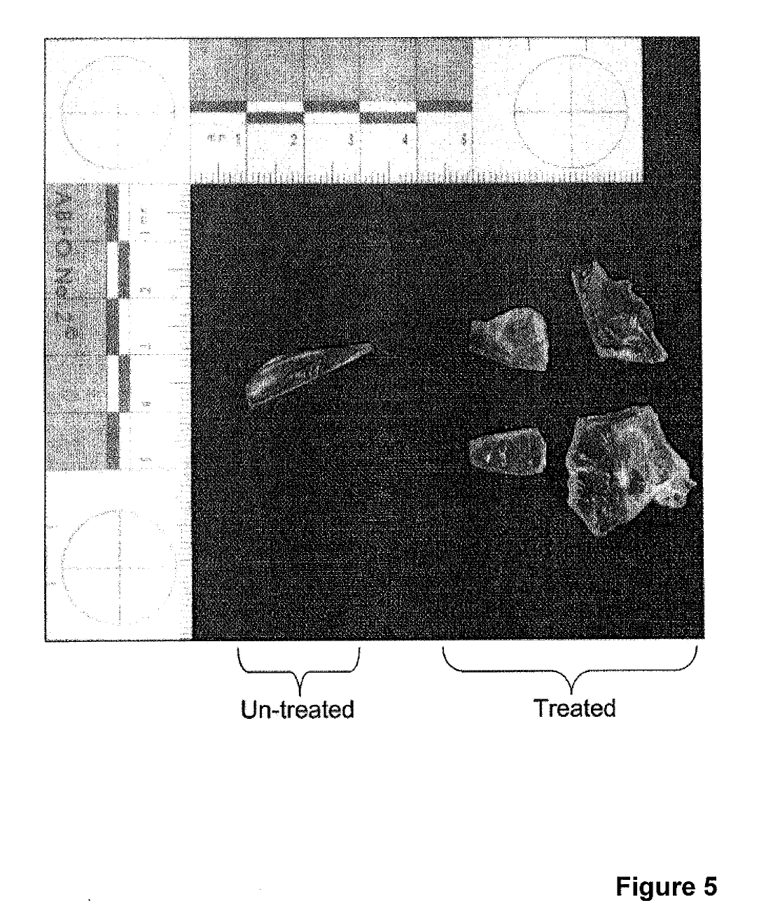

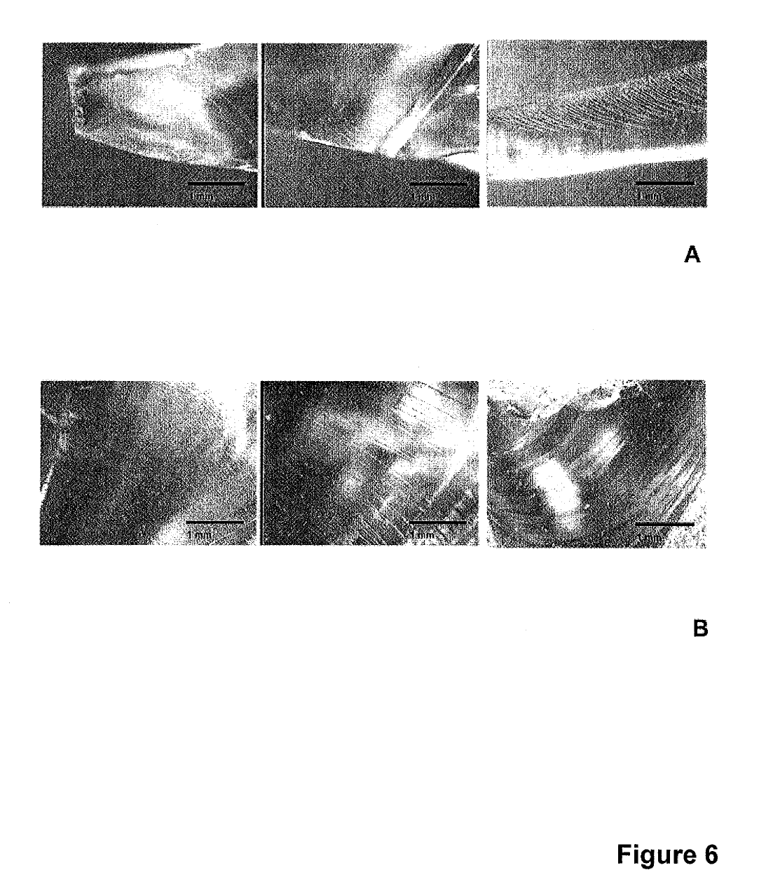

Treated glasses from Example 3 along with un-treated glasses were fragmented on a ⅛″ thick 4″×4″ plaque of annealed glass surface using a 16 oz. drop ball. As shown in the image in FIG. 5, fragments recovered from untreated glass appeared to contain sharper edges than the fragments from treated glass. More focused views of those fragments are shown in FIG. 6, where un-treated glass (FIG. 6A) is compared with treated glass (FIG. 6B). Generally, the treated glass fragments appeared to be smoother and more rounded.

### Example 5

### Resistance of Treated Glass to Piercing by Bullets

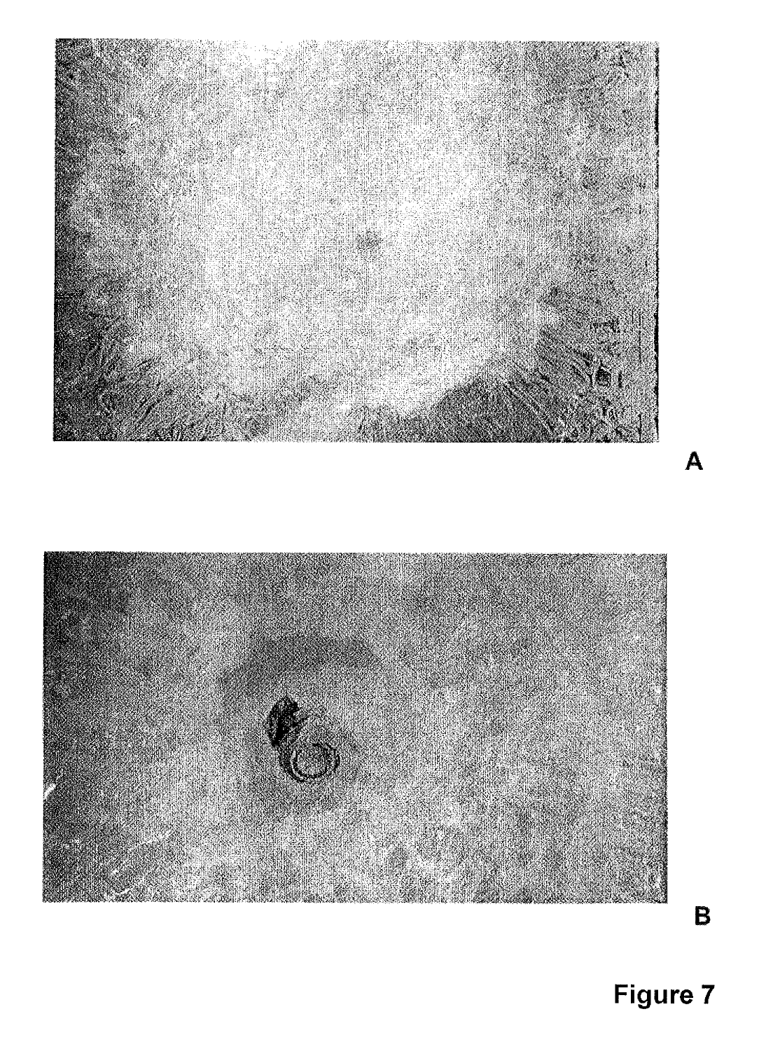

Glasses with an approximate thickness of about ½ inch were treated in accordance with the protocol set forth in Example 3 and embedded in a glass laminate structure that comprised a polycarbonate film. Thereafter, a treated glass as well as a 1 inch thick untreated glass were each shot with one bullet in accordance with the standard set forth in the HMMWV (M1114) Transparent Armor Performance Specification (herein incorporated by reference in its entirety). As shown in the image in FIG. 7A, the bullet penetrated the 1 inch un-treated glass. In contrast, as shown in FIG. 7B, the bullet failed to penetrate the ½ inch treated glass. Instead, it remained within the glass laminate structure.

The glass hardening methods and compositions of the present invention may be used to produce transparent and lightweight glasses with enhanced strength. Such enhanced strength may include, without limitation, resistance to penetration by various objects (e.g., bullets), resistance to shattering, and resistance to fracturing. The glass hardening methods and compositions of the present invention may also be used to produce glasses with a higher impact resistance per cross-sectional area than conventionally-prepared hardened glasses. Accordingly, the glass hardening methods and compositions of the present invention can have various applications in numerous fields. For instance, hardened glasses produced by the methods and compositions of the present invention may be used in various vehicles (e.g., without limitation, automobiles, trucks, buses, planes, trains, tanks, humvees, etc.), buildings, sun-glasses, optical glasses, watches, military hardware, medical devices, and other objects for various security and/or safety purposes.

Another advantage of the glass hardening methods and compositions of the present invention is their ability to treat glass substrates with curvatures in an efficient and effective manner. For instance, the compositions and methods of the present invention can be used to treat bent glasses, curved glasses, and the like.

From the foregoing description, one skilled in the art can easily ascertain the essential characteristics of this invention, and without departing from the spirit and scope thereof, can make various changes and modifications of the invention to adapt it to various usages and conditions. The invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes to the claims that come within the meaning and range of equivalency of the claims are to be embraced within their scope. Further, all published documents, patents, and applications mentioned herein are hereby incorporated by reference, as if presented in their entirety.

1. A composition for hardening glass comprising:
a. one or more silane-based compounds, wherein said one or more silane-based compounds constitute from about 60% by weight of said composition to about 100% by weight of said composition;
b. one or more glycols; and
c. one or more alcohols.

2. The composition of claim 1, wherein said one or more glycols constitute from about 0.001% by weight of said composition to about 40% by weight of said composition.

3. The composition of claim 1, wherein said one or more glycols are selected from the group consisting of propylene glycol, ethylene glycol, polyethethylene glycol, and silicon glycol.

4. The composition of claim 1, wherein said one or more alcohols constitute from about 0.001% by weight of said composition to about 25% by weight of said composition.

5. The composition of claim 1, wherein said one or more alcohols are selected from the group consisting of methanol, octanol, ethanol, propanol, iso-propanol, butanol, cyclohexanol, and phenol.

6. The composition of claim 1, further comprising water.

7. The composition of claim 6, wherein said water constitutes from about 0.001% by weight to about 40% by weight of said composition.

8-11. (canceled)

12. A method of hardening glass, wherein said method comprises:
a. applying a composition comprising one or more silane-based compounds to a glass; and
b. incubating said glass with said composition under vacuum force.

13-14. (canceled)

15. The method of claim 12, wherein said application takes place under vacuum force.

16. The method of claim 15, wherein said vacuum force is applied to said glass before said application of said composition to said glass.

17. (canceled)

18. The method of claim 12, wherein said application and said incubation take place in a container.

19. The method of claim 18, wherein said container is covered during said incubation.

20. The method of claim 12, wherein said one or more silane-based compounds constitute from about 60% by weight of said composition to about 100% by weight of said composition.

21-24. (canceled)

25. The method of claim 12, further comprising facilitating said glass hardening method by applying a curing agent to said composition.

26-29. (canceled)

30. The method of claim 12, further comprising heating said glass before said application.

31-36. (canceled)

37. A piece of glass hardened by the method of claim 12.

38-40. (canceled)

41. A hardened glass comprising:
a. a glass; and
b. a layer, wherein said layer is formed by applying a composition comprising one or more silane-based compounds to said glass, and wherein said one or more silane-based compounds constitute from about 60% by weight of said composition to about 100% by weight of said composition.

42. A vehicle comprising glass hardened by the method of claim 12.

43. A vehicle comprising the hardened glass of claim 41.

44. A kit comprising the composition of any of claim 1.
